(19) United States
(12) Patent Application Publication
(10) Pub. No.: US 2010/0138747 A1
(43) Pub. Date: Jun. 3, 2010

(54) Interactive Digital Media Frame

(76) Inventors: Heikwan Cheng, Herndon, VA (US); Yueqing Zhang, Shanghai (CN)

Correspondence Address: Heikwan Cheng, 12940 Cedar Glen Lane, Herndon, VA, 20171, US

(21) Appl. No.: 12/258,433

(22) Filed: Nov. 28, 2008

(51) Int. Cl. G06F 3/048; G06F 7/06; G06F 17/30; G06F 15/16

(52) U.S. Cl. 715/733; 709/203; 707/E17.008; 707/E17.016

(57) ABSTRACT

The present invention allows for a content provider to interact with a user on a Digital Media Frame (DMF) in real time is disclosed.

From a DMF coupled with a network, content is displayed. The user inputs data on DMF with regard to the displayed content. A content provider hosting receives the user's input with the identification information of the DMF. From the content provider's network server, in response to receiving the input data, actions are performed. The content provider hosting sends new content to the DMF.

Features of the present invention will be apparent from the accompanying drawings and from the detailed description which follows.

### SUMMARY OF THE INVENTION

The present invention allows for a content provider to interact with a user on a Digital Media Frame (DMF) in real time is disclosed.

From a DMF coupled with a network, content is displayed. The user inputs data on DMF with regard to the displayed content. A content provider hosting receives the user's input with the identification information of the DMF. From the content provider's network server, in response to receiving the input data, actions are performed. The content provider hosting sends new content to the DMF.

Features of the present invention will be apparent from the accompanying drawings and from the detailed description which follows.

### DEFINITIONS, TERMS, ELEMENTS

Internet is used interchangeably with the term Web. Both of these terms are defined as the worldwide network of PCs, servers, and other devices.

Content means information displayed in the forms of digital files or streams. For instance, content may be photo images, news text, video clips, or audio files in MP3 format.

Data means information such as requests or responses from devices sent back and forth among systems. “Data” and “Content” are used interchangeably.

HTTP is Hyper-text transfer protocol, the protocol used by Web browsers and Web servers to transfer files, such as text and graphic files.

DMF is Digital Media Frame, the digital displaying device which displays digital images, playbacks digital video files and audio files.

Network Content Provider is an entity who provides digital contents over a network, which includes digital information, digital images, digital videos and audio files. The digital information includes news, weather, traffic reports, audio files, and video files.

Network Content Provider Hosting is the networked server of the Content Provider that hosts the content. The hosting supports the network protocols and can be accessed by the content consumers to retrieve the content data. “Hosting” and “Host” are used interchangeably.

Network is a group of connected computers or electronic devices. Internet, WAN, and LAN are three forms of networks.

### PATENT BACKGROUND

With the growth of the popularity of the digital photography, Digital Media Frame (DMF) has evolved rapidly into a viable consumer electronics business by providing direct and convenient image displaying in digital data format.

Most of conventional DMFs accept the commonly employed digital media storage devices including USB memory stick, Secure Digital (SD) card, and Compact Flash (CF) card, by providing build-in adaptor slots. Such DMFs start displaying digital images after a digital media device containing image files is inserted.

Another newly employed approach is to equip the DMF with a network connection, which connects the frame to Internet. Different DMF products adopt different approaches to download digital images or other media files like audio or video files from Internet content hosts onto. DMFs. Popular internet content hosts include Flickr, Picasa and Photo Bucket.

One networking approach is to connect the DMF to a networked PC via either a USB connection or a network connection. PC downloads the media files first and then transfers them to the DMF. This approach requires either PC application software or its operating system equipped with built-in capability of sharing media file.

Other DMFs adopt a more advanced networking approach by downloading digital media files from a designated web host directly. The web host can be a proxy host with a user interface that aggregates multiple content feeds, mostly in form of RSS feed, from multiple other content hosting servers. The web host can also be the content provider hosting server itself.

All above media loading approaches are unidirectional. Users of the DMFs are the passive recipients of the media files displayed on the DMF. Users can configure the content sources via different kinds of configuration interfaces; however, they won't be able to interact with the displayed content in real time.

### BRIEF DESCRIPTION OF THE DRAWINGS

The present invention is illustrated by way of example and not limitation in the accompanying figures.

FIG. 1 illustrates a connection schema between DMF and content provider hosting.

FIG. 2 illustrates a block diagram of multiple DMFs interact with a single content provider.

FIG. 3 illustrates a block diagram of a DMF in accordance with an embodiment of the present invention.

### DETAILED DESCRIPTION

The present invention allows for content provider to interact with at least one user on a Digital Media Frame (DMF) in real time is disclosed.

DMF displays digital images that include photos, graphical images, or images converted from text. The recent generation of DMFs is also capable of playback digital video and audio files. DMF receives images, audio or video files from plug-in media storage like CF or SD cards, or from internet or LAN content hosts.

In the present invention, DMF is equipped with input devices. A convenient input device for users is the build-in touch screen, but it can also be any of an attached keyboard, a mouse device, build-in buttons, a USB connected PC, a motion sensor, or a remote control. Users may input data based on the current displayed content, or input a content selection. The input is sent to the content host with user's identification information or the identification information of the frame. The content provider can either perform actions based on users' request, or update the displayed content on DMF accordingly. The content provider can also process the users' input for multiple purposes including social networking analysis, feedback analysis, or payment information collection.

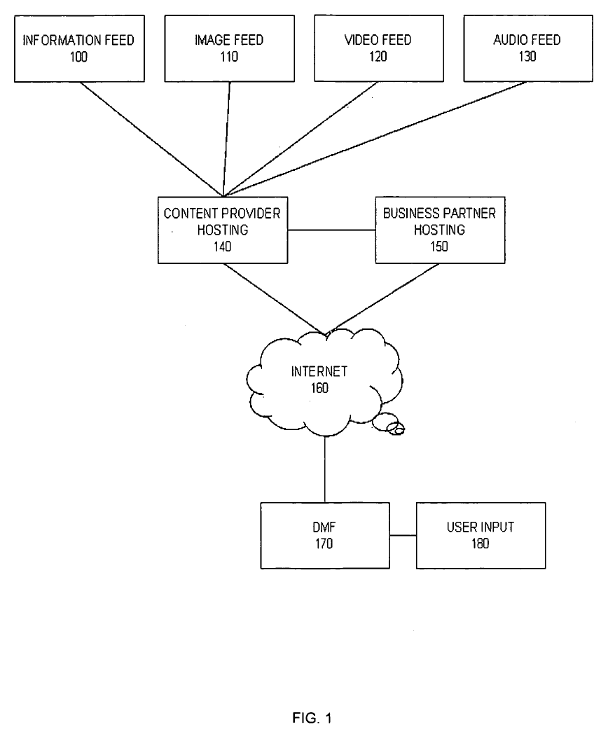

FIG. 1 illustrates an embodiment of a connection between DMF 170 and content provider hosting 140. The connection includes a DMF 170, a Content Provider Hosting 140, a Business Partner Hosting 150, and multiple content feeds that include Information Feed 100, Image Feed 110, Video Feed 120, and Audio Feed 130. It will be apparent that additional equivalent content feeds can be similarly connected to the content provider hosting. User Input 180 may include different kind of users' input that includes touches, button press, PC commands, and video, image, or audio data input.

The DMF 170 can be any kind of Digital Media Displaying Frame that can display digital images, playback digital video and audio files. In this embodiment, it also has input devices for users to input either information regarding the content being displayed, or users' preferences and content selections. The input device can be any of a touch screen, buttons, connected PCs, a connected keyboard and a mouse, a motion sensor, and a remote control. The DMF is connected to the Internet via a network connection. This network connection can be either a Wired Ethernet connection or a wireless connection including any of Wi-Fi, Bluetooth, or WiMax connections. The DMF is capable of sending and receiving messages under common network protocols including HTTP over TCP/IP. Via Internet, the DMF receives content data from the Content Provider Hosting 140 in form of digital files and displays them to the User. The DMF also receives user's input in real-time and sends the input data to the Content Provider Hosting. The DMF doesn't have to identify itself with the Content Provider Hosting when requesting publicly available content data. However, when it sends in user's input that is uniquely valid for the user, it can attach user's authentication data along with user's input messages. The user can input user's identification and authentication information with the input devices of the DMF.

The Content Provider Hosting 140 can be any kind of web host that provides data feeds that include any of images, videos or audio files to the DMFs over a network. A common way of data delivery is in form of RSS (Real Simple Syndication) feed. The content provider can be a web content provider that broadcasts contents across Internet that doesn't limit its target to DMF devices. An example of this type of service provider is Flickr.com who provides open RSS access to all public photo sets to all Flickr users. The content provider can also be a web host that targets its services to DMFs or even one brand of DMFs. In this case, most likely each DMF user needs to create a user identification to uniquely identify the DMF, so that when DMF polls the content from the Content Providing Hosting, it is polling the contents that are specifically designated for this particular DMF. The content provider can take multiple input feeds from other content-feed providers on the Internet. It will aggregate the feeds before sending it down to DMF.

The Business Partner Hosting 150 can be an online service provider that has a business partnership with the Content Provider Hosting 140. Upon receipt of users'input data, the content provider can direct certain business service request to the Business Partner Hosting 140 to handle the service requests deducted from users' input data. An example of this embodiment will be that after viewing a Movie Trailer on the DMF, user inputs a request to purchase a movie ticket. The content provider that feeds the DMF with the movie trailer video file receives user's request with user's payment data. It will then forward this request to a Movie Cinema service provider to purchase the movie ticket on behalf of the user.

The User Input 180 can be any kind of data user input via different type of input devices including any of a touch screen, buttons, an attached PC, an attached keyboard, a mouse, a motion sensor, and remote control. User's inputs are received and stored by the DMF and then sent to the content provider via the network connection.

The Content Feeds (100-130) can be any kind of web hosts that provides content feeds to users on the Internet. A common way of data delivery is in form of RSS (Real Simple Syndication) feed. A couple of examples of this type of services are the real time stock price quote feed provided by Scottrade.com and the real-time weather feed provided by weather.com. Flickr.com can also be a content feed provider that feeds images to a Content Provider Hosting before the multiple feeds are aggregated and fed to the DMFs.

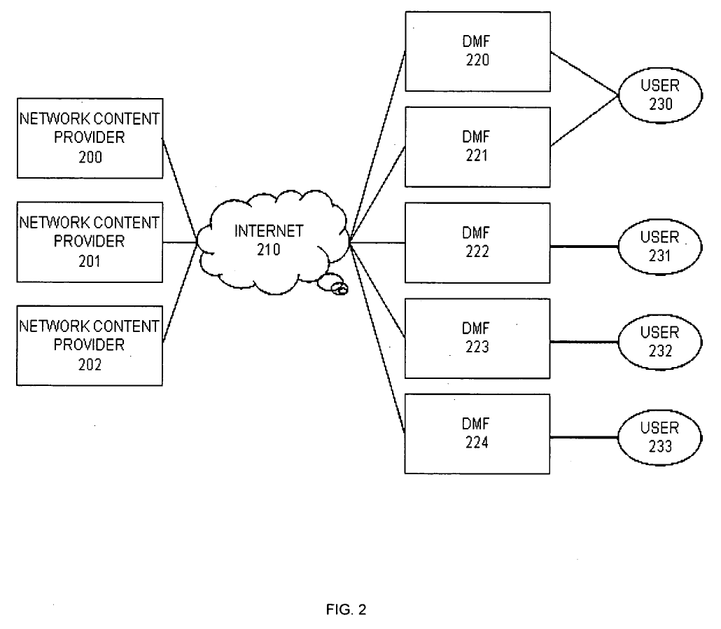

FIG. 2 illustrates an embodiment of connection between multiple Content Providers 200-202 and multiple interactive DMFs 220-224 and their Users 230-233. Each DMF is capable of receiving content from one or multiple Network Content Providers and sending Users' input to one or multiple Content Providers, while each Content Provider feeds content to multiple DMFs and processes input from multiple Users.

Each Content Providers 200-202 can be any kind of web host that provides data feed that includes images, videos or audio files to the DMFs 220-224 over Internet 210. Like the Content Provider Hosting 140 in FIG. 1, the content provider can be generic content provider that broadcasts contents across Internet, or a Web host that targets its service to multiple DMFs or even one specific brand of DMFs. The content provider can take multiple input feeds from other content feed providers on the Internet and aggregate the feeds before send it down the DMFs. The Content Provider offers each content feed with unique accessible address. A common implementation is the URL address of the RSS feed. The accessible address can also be a unique name or identification number, which can be associated with an Internet Protocol address or an URL. The content defined in the feed can be updated by the Content Provider either periodically or randomly. The feed contains the duration of its content validity which triggers the DMFs to poll the feed again upon its expiration. A publicly accessible address of the content feed can be polled by multiple DMFs, which results in the same content to appear on multiple DMFs 220-224. The access of the content feed can also be restricted to limited DMF(s). In this case, user authentication information or frame identification information is needed to authenticate the requester to poll the content feed.

The DMFs 220-224 can be any kind of Digital Media Displaying Frame like the DMF 170 defined in FIG. 1. Each DMF 220-224 can display digital images, or playback digital video and audio files. In this embodiment, each DMF also has input devices for user to input data either based on the content displayed or played, or to input user's preference or content selection. DMFs 220-224 are connected to Internet 210 via a network connection. Each DMF 220-224 can connect to multiple Content Providers 200-202 or multiple content feeds provided by single or multiple Content Providers 200-202. In one example, using the input devices of the DMF 220, User 230 inputs the content selection which can be an accessible address like a Feed URL or the name of the content feed. The DMF 220 requests the content by polling the feed using the accessible Feed URL entered by user or the accessible URL converted from the name of the content feed. The DMF 220 can either display the content in a round robin cycle or just display certain content specified by the user input. After viewing the displayed content, Users 230 can input data that can be in form of images, video stream, audios, data selection, or text input regarding the content. The DMF 220 then forwards users input to the Content Provider 200 with the User's or DMF identification and the content identification. The Content Provider 200 can process the input data and decide if the future content feed to the DMF shall be adjusted.

The Users 230-233 can be anyone uses or own the DMFs 220-224. A user can use or own one or multiple DMFs. Users 230-233 input the content selection with the input devices of the DMFs 220-224. Users 230-233 view the displayed content which can be images, text, videos, audio, or combined content. Users can set up the input selection for long term use. For example, a user can subscribe to one photo album feed to an online photo sharing site and the DMF will continue displaying the updated content of the photo feed till user decides to change it. A user can also input a real time content selection to get short term information content. For example, the user can select to receive the latest weather, stock, or traffic information update from the online information provider. The short term content is updated frequently and the DMFs 220-224 will display the content for short term only when the User 230-233 needs it.

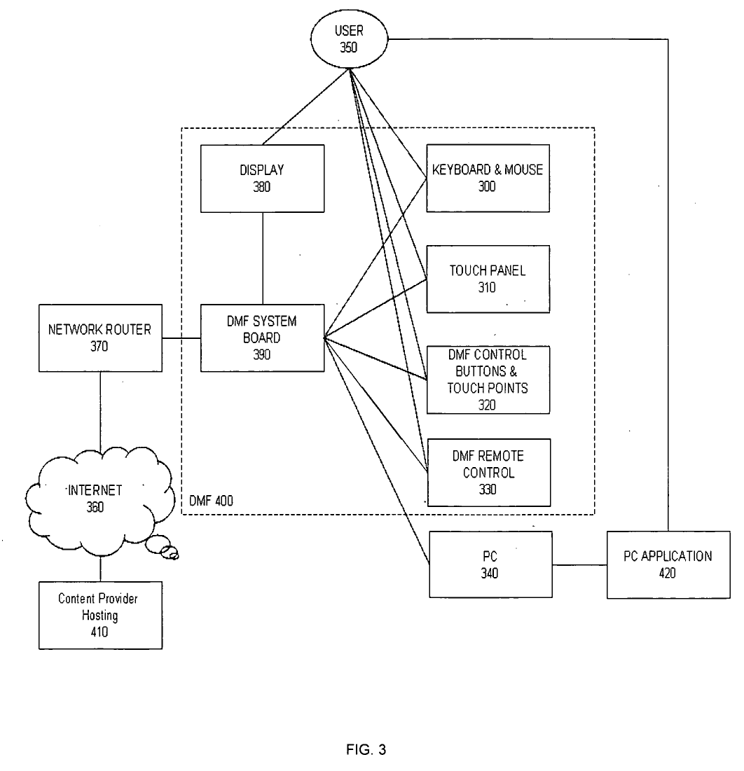

FIG. 3 illustrates an embodiment of a DMF 400 that contains Input Devices 300-330 and connects to Content Provider Hosting 410 via Internet 360. User 350 uses Input Devices 300-340 to input content selection or feedback to the displayed content. The Input Device 300-330 can be either a build-in part of the DMF 400, or a device on the attached PC 340.

The Content Provider Hosting 410 is as defined as the Content Provider Hosting 140 in FIG. 1. It receives User's content selection and feedback input from the DMF 400 via internet. It sends the content to DMF 400 via Internet.

The Network Router 370 can be any of network access points where a network device can be connected to Internet 360. This network router can be either an Ethernet router or a wireless router that is based on Wi-Fi or other wireless technologies. Many network routers assign Local Area Network (LAN) Internet Protocol (IP) addresses to connected devices.

The DMF 400 can be any kind of Digital Media Displaying Frame like the DMF 170 defined in FIG. 1. The DMF 400 contains a network adaptor that connects to the Network Router 370. The network adaptor of the DMF can be either an Ethernet network adapter that connects to Ethernet network connection or a Wireless network adaptor that connects to a wireless network router.

The Display 380 can be any kind of display devices utilizing the different kinds of displaying technologies like the LCD and OLED flat panel displays. The Display device 380 receives displaying signals from the DMF System Board 390. User 350 views the images, video or information displayed on the Display 380.

The DMF System Board 390 is the system control part of the DMF 400. It hosts the network adaptor, Central Processing Unit, Internal Memory, Display adaptor and other system components that construct of the main system implementation of DMF 400. The components of the DMF System Board 390 can reside on separated physical boards but are connected by circuit buses or wires.

Keyboard & Mouse 300, Touch Panel 3 10, DMF Control Buttons & Touch Points 320, DMF Remote Control 330 are all possible input devices for User 350 to input data to the DMF 400. Keyboard and Mouse 300 can be connected to the DMF System Board 390 with either wired or wireless connection. The touch panel is often laid on top of the Display 380 to allow the User 350 to directly interact with displayed images, displayed buttons or icons, and other touchable image items displayed on Display 380. Control Buttons 320 are often built on the back or side of DMF 400, providing simple input commands such as “menu”, “up”, “down”, “select”, etc. Different frames may have different button designs. Touch Points 320 are touch sensors built on the surface of the frame, often on the side of the Display 380. Display 380 displays descriptive text of commands next to the touch points. Touch Points 320 input the command corresponding to the instruction displayed when the touch point next to it is touched. DMF Remote Control 330 is a device for User 350 to input commands remotely by pressing the predefined key on the control. The DMF System Board 390 receives the command via its remote control receiving sensor. All the input devices serve the purpose to allow the User 350 to input either data of content selection or feedback to the displayed content.

The PC 340 is connected to the DMF 400 via either wired or wireless connection. The connection can be a Wi-Fi ad-hoc connection or a direct USB connection. PC Application 420 runs on PC 340. From the PC Application 420, User 350 can input the content selection, DMF configuration or feedback to the displayed content.

User 350 can be anyone uses or owns the DMF 400. User 350 inputs the content selection with the input devices 300 - 340 of the DMF 400. User 350 views the displayed content which can be any of images, text, videos, audio, or combined on the Display 380.

### ADVANTAGES OF THE INVENTION COMPARED TO PRIOR ART

One advantage of the present invention provides the real time input and feedback from the user to the network content provider. This feedback converts the one-way communication of the passive content reception of the DMF users to a two-way real time communication. Content provider can now present content that better targets users' need in real time. It is also possible to form a social network of the users based on the real time feedback and input to the displayed content.

This invention also greatly increases the ease of the use of DMF to its users. With the conventional DMF approach, users need to access the content management website to manage the content fed to the frame. Most of the conventional DMFs present all content in a round-robin fashion and user will have to wait for the next cycle to view any specific content. With the new invention, users can manage and select the content at any time.

This invention saves the network resource of both DMF and the content provider hosting, since for real time information content including news, weather, traffic conditions, etc., conventional DMFs need to periodically fetch all content to the frame even though the user may only be interested in a very few portion of the content. With the new approach, user can select the interested content and the content provider will deliver that piece of content to the DMF in real time.

What is claimed is:

1. A method for users of digital media frames (DMFs) to interact with at least one content providers over a network, which comprising the steps of:
a. selecting content displayed on at least one DMF based upon at least one user's inputs on an input device;
b. sending the user's content selection inputs from the at least one DMF to the content provider via the network;
c. providing selected content onto the at least one DMF by the content provider pushing or DMF polling;
d. inputting feedback data or action commands regarding content displayed on at least one DMF by the at least one user using the input device;
e. sending the user's feedback data or action commands from the at least one DMF to the content provider along with an identifier of the content displayed; and
f. updating the content displayed on at least one DMF by the content provider, or conducting business transactions with other online service providers based on users' action commands.

2. A method as recited in claim 1 wherein: the content is digital files including any of digital images, digital videos, digital audios, and digital text.

3. A method as recited in claim 1 wherein: the input device of DMF can be any of a touch panel, a keyboard and a mouse, build-in buttons, touch points, a motion sensor, an PC, and a remote control.

4. A method as recited in claim 4 wherein: the input device of DMF is connected to the DMF via a connection that includes any of a USB connection, a Bluetooth connection, an Ethernet connection, an Infra-Red connection or a connection with parallel or serial ports.

5. A method as recited in claim 4 wherein: A PC connected to the DMF contains a software application that allows users to input data.

6. A method as recited in claim 1 wherein: the DMF is connected to a network via a wire line or a wireless connection that can be any of a Wi-Fi connection, an Ethernet connection, a USB connection, a Bluetooth connection, an Infra-Red connection, WiMax connection, and mobile data network connections.

7. A method as recited in claim 1 wherein: A content provider provides content feed to a DMF via network protocols including HTTP over TCP/IP.

8. A method as recited in claim 1 wherein: The input data sent from DMF to the content provider optionally contains the identification data of the content displayed, identification of the user, or/and the identification of the DMF.

9. A method as recited in claim 1 wherein: The content provider publishes digital text or digital files on Internet with accessible address in the format of URL.

10. A method as recited in claim 1 wherein: The network is comprised of connected computers or electronic devices, including any of WANs, LANs, and Internet.

11. A Digital Media Frame comprising an input device and a network connection thereon is able to send user's content selection and input data regarding displayed content to perform the method of claim 1.
